(19) United States
(12) Patent Application Publication
(10) Pub. No.: US 2014/0052462 A1
(43) Pub. Date: Feb. 20, 2014

(54) OUTCOMES DATA COLLECTION AUTOMATION AND HAND-OFF DISPLAY TECHNIQUES

(71) Applicant: CEDARON MEDICAL, INC., Davis, CA (US)

(72) Inventor: Malcolm L. Bond, Winters, CA (US)

(73) Assignee: CEDARON MEDICAL, INC., Davis, CA (US)

(21) Appl. No.: 13/963,959

(22) Filed: Aug. 9, 2013

Related U.S. Application Data
(60) Provisional application No. 61/684,590, filed on Aug. 17, 2012.

(51) Int. Cl. G06Q 30/02; G06Q 50/22

(52) U.S. Cl. CPC G06Q 30/0203; G06Q 50/22
USPC 705/2

(57) ABSTRACT

Methods and systems are described for creating health status surveys using questions automatically derived from codes of the International Classification of Functioning, Disability and Health (ICF), promulgated by the World Health Organization, and then automatically scheduling the surveys to be provided to patients and their clinicians. Results from the surveys can be compared against results from patients with similar medical diagnoses or surgical procedures. Survey results from patients with different medical diagnoses or surgical procedures can also be compared for questions derived from the same ICF code, resulting in greater pools of data from which to extract statistics.

### CROSS-REFERENCES TO RELATED APPLICATIONS

This application claims the benefit of U.S. Provisional Application No. 61/684,590, filed Aug. 17, 2012, which is hereby incorporated by reference in its entirety for all purposes.

This application is has subject matter relating to U.S. Pat. No. 6,177,940 for “Outcomes Profile Management System for Evaluating Treatment Effectiveness,” issued Jan. 23, 2001 to Malcolm L. Bond and Bruce Richard Chapman, the entire disclosure of which is hereby incorporated by reference for all purposes.

### STATEMENT AS TO RIGHTS TO INVENTIONS MADE UNDER FEDERALLY SPONSORED RESEARCH AND DEVELOPMENT

NOT APPLICABLE

### BACKGROUND

1. Field of the Art

Generally, the present application relates to data processing. Specifically, the application is related to automatic health status survey question generation, questionnaire scheduling, and analysis.

2. Discussion of the Related Art

In 1913, Dr. Ernest A. Codman published material regarding the “Standardization of Hospitals” setting forth the concept of ‘End Results.’ The End Results proposal espoused the need for documenting the effects of health care treatment as an integral part of daily patient chart activity. Dr. Codman believed in following patients to determine if delivered treatments proved successful and to provide healthcare with a new quantitative platform from which it would be possible to tune pathways of care to achieve improvements in care. Codman's work anticipated contemporary approaches of outcomes studies.

For over one hundred years, the healthcare industry has made efforts to achieve Dr. Codman's ideal of tracking the ‘End Results’ for every patient. Unfortunately, complex, ambiguous health care objectives, decision making, and costs have hindered the widespread realization of Dr. Codman's vision.

Although there are some health care disciplines that have achieved significant results in this area, the majority of outcomes programs adopted by healthcare providers have had only marginal success. In fact, the health care industry in general is frustrated with outcomes measurement initiatives. While many are engaged in the process, no one appears to be completely satisfied that the right information is being collected.

The reasons for tracking outcomes in today's healthcare environment closely follow Dr. Codman's original thoughts of pursuing a quantitative understanding of interventions delivered in treating health conditions. From a social perspective, outcomes documentation is recognized has having the potential to expose metrics of cost and burden for a health condition. From a clinical perspective, outcome metrics are believed to have value in defining critical care pathways and possibly altering the natural progression of health conditions.

As mentioned above, the practicality of implementing an outcomes program is fraught with difficulties. Most notably among the impediments is the fact that standardized, easy to use outcomes measures simply are not available. The move to implement outcomes programs on a broad scale has deteriorated with a low percentage of outcomes program adoption by the healthcare industry.

Insurance payers and governmental legislative bodies are increasingly demanding healthcare providers document patient outcomes and treatment effectiveness. The increased workload on healthcare providers to furnish this documentation has caused hardship on healthcare staff.

Current computerized methods of collecting health status and medical treatment outcomes data utilize kiosks and interactive graphical interfaces. Patients, or their clinicians, answer custom questionnaires on the kiosks during an appointment with the clinician.

A problem with these kiosk methods is that, despite being computerized, they are time intensive for the healthcare staff to operate. A typical workflow begins with staff scanning medical records to determine the treatment outcomes profile of each patient. The treatment outcomes profile measures change and progress in key areas of the life of a patient. Next, staff select questionnaires appropriate for the outcomes profile of the patient, which may be repeatedly given to a patient.

Not only is this process time intensive, but mistakes can be made anywhere in the workflow. Initially, staff may not accurately profile each patient. The selection of the outcomes questionnaire or survey suitable for the patient profile may not be correct. More errors may be made in attempts at synchronizing the presentation of the survey at the appropriate milestones within the episode of care as dictated by a cohort definition.

The term “cohort” is used in its statistical sense of a demographic grouping of people, such as those in a defined age group, having a common characteristic, or as otherwise known in the art.

Methods that expose the integrity of the collected data to errors, particularly errors in maintaining a high degree of accuracy in the periodicity of the questionnaire, thwarts the intended usefulness of the aggregation of data.

Further, there exists an unsatisfied demand for greater visibility of the resulting outcomes metrics. While systems presently exist which are capable of collecting patient data, albeit with the associated problems mentioned here, many systems rely on ad hoc data analysis techniques of the analysis results. Such systems have ignored the need of certain stakeholders in a patient's episode of care to be informed of patient status.

A further understanding of the nature and advantages of the present invention may be realized by reference to the remaining portions of the specification and the drawings, which are intended to be exemplary and not limiting.

### BRIEF SUMMARY

Generally, health status surveys containing questions derived from codes in the World Health Organization's (WHO's) International Classification of Functioning, Disability and Health (ICF) are automatically presented to patients, or their clinicians, through medical center kiosks or email, and their answers to the questions are used to build a statistical model of improvement rates that can be used for patients with different ailments. The initial selection of the survey for a patient can be automatic and according to the patient's demographics and/or medical diagnosis or surgical procedure. An automatic selection of the survey can be followed by automated scheduling of follow up surveys, containing the same or different standardized questions, over a time period or series of events. The follow up surveys can then be automatically sent or otherwise presented according to the schedule to the patient via email, etc.

Survey results of one patient can be compared with statistical data from other patients with the same or different ailments and presented to stakeholders so as to compare the rates of rehabilitation. Because the questions are derived from standard ICF codes, answers to survey questions in different disciplines, in which the questions were derived from the same code, can be compared. Large sets of statistical data can be acquired this way. The statistical data can be compared with a patient's recent survey response, and the results can be displayed on a large screen in a waiting room, nurses' station, etc.

An embodiment of the invention is related to a method of quantifying and assessing patient health. The method includes providing a first health status survey pertaining to a first medical diagnosis or surgical procedure, the first health status survey including a question for quantifying a functional ability of a body portion or organ according to a standard classification of functioning of the body portion or organ, providing a second health status survey pertaining to a second medical diagnosis or surgical procedure, the second health status survey including a question for quantifying the functional ability of the same body portion or organ according to the standard classification of functioning of the body portion or organ, wherein the first and second medical diagnoses or surgical procedures to which the first and second health status surveys pertain are different from one another, receiving reported results in response to the first and second surveys of different medical diagnoses or surgical procedures, the reported results corresponding to the questions quantifying the (same) functional ability of the body portion or organ, calculating, using a processor operatively coupled with a memory, a statistical average rate of change of the functional ability of the body portion or organ using the reported results, comparing a first reported result in response to the question from a first patient with a value calculated using the calculated statistical average rate of change, and causing a result of the comparison to be displayed.

Optionally, the standard classification of functioning of the body portion or organ is from the International Classification of Functioning, Disability and Health (ICF) as promulgated by the World Health Organization. The comparing can include a rate of recovery comparison, and the displaying can be accomplished on a large format display in a nurses station or family waiting area.

An embodiment relates to a method of quantifying and assessing patient health. The method includes providing a set of health status surveys, each health status survey including a question for quantifying a functional ability of a body portion or organ according to a standard classification of functioning of the body portion or organ, receiving patient information regarding a medical diagnosis or surgical procedure for a patient, automatically selecting a first health status survey from the set of health status surveys based on the received patient information, automatically providing the first health status survey to the patient, receiving a reported result for the patient corresponding to the question in the first health status survey, automatically selecting a timeline for one or more additional health status surveys to be provided to the patient, the selecting based on the reported result, and automatically providing to the patient the one or more additional health status surveys according to the selected timeline.

Optionally, the method can further include selecting a rehabilitative goal for the patient based on the reported result and selecting functional ability codes based on the rehabilitative goal, the functional ability codes selected from the standard classification of functioning of the body portion or organ. The timeline can include specified time periods between surveys and/or specified visits to a clinician. The method can further include selecting the one or more additional health status surveys based on the reported result. The method can include selecting the first patient survey based on a patient demographic as well as emailing the first health status survey to the patient or presenting it at a kiosk.

An embodiment relates to a method of quantifying and assessing patient health. The method includes providing a first health status survey pertaining to a first medical diagnosis or surgical procedure, the first health status survey including a question for quantifying a functional ability of a body portion or organ according to a standard classification of functioning of the body portion or organ, automatically selecting a first schedule of dates to provide to a first patient the first health status survey, automatically providing to the first patient the first health status survey according to the first schedule of dates, receiving first reported results in response to the first health status survey, the first reported results corresponding to the question, interpolating, using a processor operatively coupled with a memory, a rate of change of the first reported results, providing a second health status survey pertaining to a second medical diagnosis or surgical procedure, the second health status survey including the question, automatically selecting a second schedule of dates to provide to a second patient the second health status survey, automatically providing to the second patient the second health status survey according to the second schedule of dates, receiving second reported results in response to the second health status survey, the second reported results corresponding to the question, comparing one of the second reported results for the second medical diagnosis or surgical procedure to a value calculated from the interpolated rate of change of the first reported results for the first medical diagnosis or surgical procedure, and causing a result of the comparison to be displayed.

Other embodiments related to machine-readable tangible storage media and computer systems that store or execute instructions for the methods described above.

A further understanding of the nature and the advantages of the embodiments disclosed and suggested herein may be realized by reference to the remaining portions of the specification and the attached drawings.

### BRIEF DESCRIPTION OF THE DRAWINGS

FIG. 1 illustrates a standard question distributed in disparate surveys over time to patients with different functional limitations in accordance with an embodiment.

FIG. 2 illustrates a standard question from the International Classification of Functioning, Disability and Health (ICF) used in different questionnaires in accordance with an embodiment.

FIG. 3 is a screenshot showing editing criteria by selecting follow-up triggers (e.g., database registration of a new patient, database registration of a new episode, patient is admitted, patient is discharged) according to an embodiment.

FIG. 4 illustrates selecting different timelines for presenting a survey to a patient according to an embodiment.

FIG. 5 is an annotated screenshot showing patient data collection automation according to an embodiment.

FIG. 6 is a is a screenshot showing testing a cohort by executing a query of the patients that match the cohort definition and then displaying the results according to an embodiment.

FIG. 7 is a screenshot of a large format display for a soft hand off in accordance with an embodiment.

FIG. 8 is a flowchart of a process in accordance with an embodiment.

FIG. 9 is a flowchart of a process in accordance with an embodiment.

FIG. 10 is a flowchart of a process in accordance with an embodiment.

FIG. 11 is a circuit block diagram of a typical computer system that can be used with embodiments.

### DETAILED DESCRIPTION

Information technologies can be used to make the collection of health data from questionnaires, which is often imprecise, into something much more precise. The more precise or accurate the data, the more usable. Health status surveys are often imprecise because different people fill them out at different times, each person filling out his or her survey based upon subjective experience at the time. Surveys can be filled out by health care patients themselves or their clinicians. Exacerbating the inaccuracies is that different surveys use different terms, definitions, and scales from one another. A health status survey from one hospital may be completely different from a survey from another hospital, even in the same city. A health status survey from one group within a medical center may be different from another group within a medical center. Rather than researching and building a standard outcomes measure with the flexibility to meet all needs, researchers have been prolific in publishing instruments arguing that each is endowed with unique insight into the functional status of patients. With different hospitals and groups using different surveys, clinicians and patients often deal with new(-to-them), unfamiliar surveys. Calibrating one's answers to a survey question, even as a highly skilled clinician, is a difficult proposition.

At the other end of the specificity spectrum, researchers have also been prolific in presenting validating arguments in support of general health measures. For example, the Medical Outcomes Study Short Form 36 (SF-36) is a general health measure. The issue around this approach is lack of sensitivity and specificity to any health condition. These generic approaches are non-specific to age, disease, or treatment group. Additionally, the instrument fails to be culturally independent and thus inhibits the cross national boundary comparisons of the relative benefits of different treatments.

Another factor working against widespread adoption of outcomes programs is the inability to seamlessly integrate outcomes into routine documentation. In many disciplines of healthcare, for example rehabilitative medicine, outcomes measures require a reference to and an association with functional goals. The required association of an outcomes measure to a goal is currently left to the staff clinician to manually draw the associative dependency. The end result of the manual linking of goal to outcomes measure, is an increased workload on the clinical end user.

Computer outcomes data collection utilities can automate outcomes data collection so that it is less prone to error. Further, standardized questions can be created automatically from world-standardized functional abilities, using language accepted by medical professionals.

“Automatically” includes without contemporaneous direct human intervention, such as through a computer executing instructions according to a predefined rule or algorithm, or as otherwise known in the art.

The computer outcomes data collection utilities can include one or more of the following:
Defining of patient cohorts, storing cohort data in a database, the cohort data comprising demographic information, health status, medical condition, classification of functioning and associated severity qualifier, acute care patient location, outpatient patient location, interventions, treatments, payer, and appointment scheduling;
Defining of relationships between surveys and cohorts;
Defining of discrete milestone within each cohort treatment episode generic time line;
Defining relationships between surveys and cohorts, and each milestone within the episode of care appropriate for the cohort;
Defining episode templates;
Relating episode templates to cohort;
Defining milestones within cohort template;
Scanning the database for newly registered patients, for example, can include one or more of the following:
   Query patient profile for match to outcomes cohort profile,
   Cohort profiles include demographic, medical condition, treatment history, physician order, anticipated discharge date, and scheduled appointments,
   Query cohort definitions,
   Initiate defined Send Milestones for matched cohort, and
   Embed in the sent message the appropriate cohort survey instruments;
Receiving from the patient each set of responses;
Aggregating the responses to each outcomes survey;
Analyzing patient progress towards achieving goals;
Comparing the progress of a patient against aggregate data and creating useful benchmark reports; and
Initiating a push presentation of outcomes metrics to all stakeholders of patient episode of care.

Once the cohort to profile match is identified, a sequence of tasks are initiated to send to the identified patients the appropriate outcomes forms that have been selected in accordance with embodiments of the invention as appropriate for the patient and the attributes of the episode of care. The automation of sending of outcomes data to patients is repeated throughout the episode of healthcare with a predetermined or alternatively at an ad hoc schedule, as detailed below.

Embodiments can include the dynamic generation of outcomes measures from globally accepted standards of classification of whole body and organ specific functions. Additionally, goals can be generated by programmatically morphing standardized classification statements. The task of associating measures to goals is moved from workload of the clinician into one of an auto-linked/auto-generation method.

Machine logic is used in presenting questions to patients which filters large classification libraries, in some cases more than a thousand questions, down to a manageable sequence of no more than ten items for responses. Such logic morphs standard functional classification language into quantifiable goals suitable for charting and demonstrating the efficacy of treatment (i.e., standardized outcomes). For example, one embodiment uses the World Health Organization's over fourteen hundred International Classification of Function codes. These codes have been designed by the WHO to be language neutral and culturally nonspecific.

Rules for morphing standard functional classification language into quantifiable goals can include the following:
1. Get ICF string
2. Make initial character in string lowercase
3. If present, remove “structure of” from beginning of string

If present, remove “additional” from beginning of string

If present, remove “, other specified” from end of string

If present, remove “, unspecified” from end of string

If present, remove “, other specified and unspecific” from end of string

If present, remove “generalized” from end of string

If present, remove “the” from string

If present, remove “basic” from string

If present, remove “one's” from string

If present, remove “radiating” from string

If present, remove “learning to” from string

If present, remove “other” from string unless followed by “than” or “buildings”

If present, replace “communicating with” with “communicating”

If present, replace “feeling bloated” with “bloated sensation”

If present, replace “tremor” with “tremors”

If present, replace “- receiving” with “by receiving”

If present, replace “- producing” with “by producing messages”

If present, replace “purposeful sensing” with “purposefully sense”

If present, replace “oneself” with “self”

If present, remove “?” from string

If string includes “ing” in a word other than “training” and associated code does not start with “e”, append “ability to” to beginning of string

If present, replace “using” with “use”

If present, replace “eating” with “eat”

If present, replace “lying” with “lie”

If present and not preceded by “by”, “a”, “while”, “around, or “use”, replace “tting” with “t”

If present and not preceded by “by”, “a”, “while”, “around, or “use”, replace “nning” with “n”

If present and not preceded by “by”, “a”, “while”, “around, or “use”, replace “pping” with “p”

If present and not preceded by “by”, “a”, “while”, “around, or “use”, replace “rring” with “r”

If string includes “ing” in a word other than “training”, associated code does not start with “e”, and word including “ing” is not preceded by “by”, “a”, “while”, “around”, or “use”, remove “ing”
If resulting word ends in “as”, “rs”, “ns”, “os”, “it”, “at”, “et”, “ir”, “ar”, “or”, “tak”, “mak”, “nk”, “g”, “d1”, “c”, “id”, or “v”, append “e” to resulting word

If associated code starts with “e1” or “e5”, append “use of” to beginning of string

If associated code starts with “e2”, “e3”, or “e4” or string is “general tasks and demands”, “household tasks”, or “support and relationships”, append “interaction with” to beginning of string

If associated code starts with “s”, append “function of to beginning of string

If associated code starts with “s”, replace “ity” with “ities” if present in string

If associated code starts with “d”, add “use” before “toilet” if present in string

If associated code starts with “d”, remove “, indoors and outdoors” if present in string

If associated code starts with “d”, add “level” after “education” if present in string

If associated code starts with “d”, add “level” after “training” if present in string

If associated code starts with “d”, add “skills” after “apprenticeship” if present in string

If associated code starts with “d9” or string includes “employment” or “transactions”, append “ability to engage in” to beginning of string

If present, remove parentheses and any characters between them

If string includes “of', move characters after “of” to beginning of string and remove “of” unless string ends with “s”, string includes “function”, “functions”, “food”, “a”, “power”, “tone”, “endurance”, or “region”, or associated code starts with “e”

If string includes commas and there is an “, and” after a comma, remove “and”

If string includes commas and there is an “and” after a comma, replace “and” with “,” unless “and” is part of “products and technology”

If string includes commas, append “and” after the final comma in the string

The resulting goal statement may be: “Patient will improve STRING, such as . . . , in order to . . . . ”

Likewise to goal statements, patient function and disability questions can be dynamically generated from each outcomes indicator. These questions are programmatically dispatched to the patient's personal computer by email or as otherwise known in the art. Furthermore, each outcomes question presented to patients includes a severity grading by the patient. Thus, the self-reported responses and severity answers offer a quantified metric of outcomes that can be tracked by patient or by patient population.

Some sample patient survey questions include the following:
Q: In your present state of health, do you have difficulty walking and/or moving around without assistance?
Q: In your present state of health, do you have difficulty changing or maintaining your body position without assistance?
Q: In your present state of health, do you have difficulty carrying, moving, or handling objects without assistance?
Q: In your present state of health, do you have difficulty washing and/or taking care of yourself without assistance?
Q: Do you have any other functional limitation not listed above?

Other sample patient survey questions include:
Q: In your present state of health, do you have difficulty swallowing?
Q: In your present state of health, do you have difficulty producing speech and/or speech sounds?
Q: In your present stated of health, do you have difficulty understanding spoken language?
Q: In your present state of health, do you have difficulty articulating and/or expressing your thoughts clearly to others?
Q: In your present state of health, do you have difficulty maintaining attention levels and/or focusing on daily tasks?
Q: In your present state of health, do you have difficulty recalling thoughts from memory and/or processing memorization tasks?
Q: In your present state of health, do you have difficulty using your voice to communicate?
Q: Do you have any other speech related functional limitation not listed above?

Answers or other responses to the questions can be made in percentage terms with qualifiers, in line with the ICF. For example, the following can be qualifiers for body functions:

| | | | |
|---|---|---|---|
| xxx.0 | NO impairment | (non, absent, negligible, . . . ) | 0-4% |
| xxx.1 | MILD impairment | (slight, low, . . . ) | 5-24% |
| xxx.2 | MODERATE impairment | (medium, fair, . . . ) | 25-49% |
| xxx.3 | SEVERE impairment | (high, extreme, . . . ) | 50-95% |
| xxx.4 | COMPLETE impairment | (total, . . . ) | 96-100% |
| xxx.8 | not specified | | |
| xxx.9 | not applicable | | |

In practicing embodiments in a medical records environment, automated methods generate outcomes profiles of the patient and metrics of progress made towards outcomes goals and comparisons to historical data of programmatically determined patient population with the same outcomes profile. These metrics are displayed in graphic form in a warm hand-off and patient outcomes tracking display for patient, healthcare provider, and patient family members.

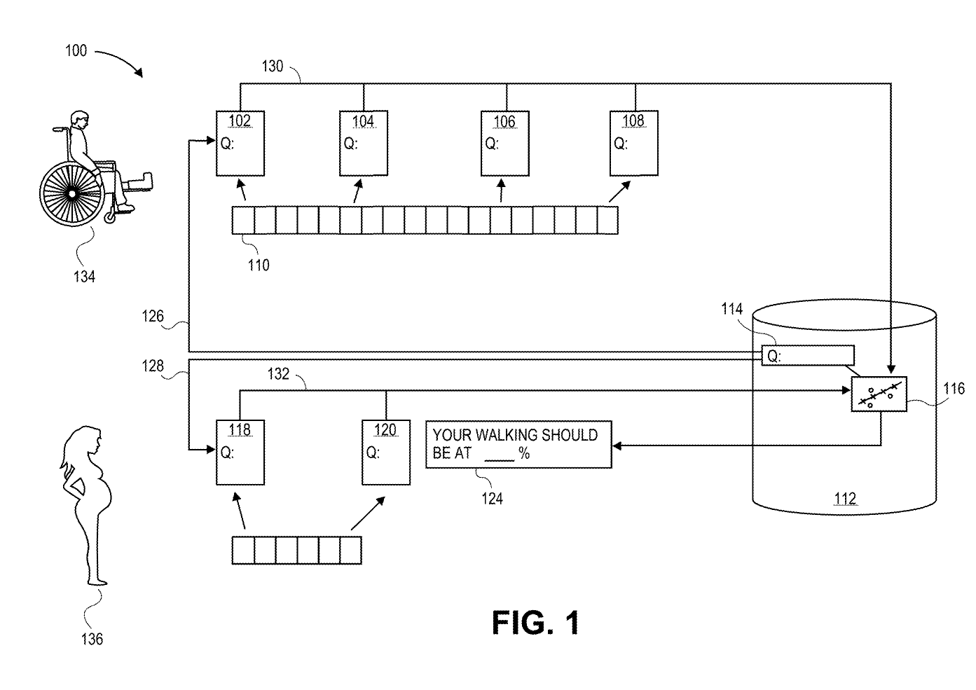

FIG. 1 illustrates a standard question distributed in disparate surveys over time to patients with different functional limitations in accordance with an embodiment. Process 100 includes questionnaires given to different patients that have different conditions over different timelines, but the questionnaires have the same question 114.

Patient 134 has a hurt leg and has difficulting walking Question 114, relating to the ability to walk, is taken from database 112 in step 126 for the questionnaires that will be presented to patient 134. In this embodiment, question 114 remains the same between the questionnaires and is not altered. In other embodiments, the question may change. Changing of the question can depend on elapsed time, answers to previous questions, and other conditions. Timeline 110 is selected for questionnaires 102, 104, 106, and 108 to be presented to the patient. That is, questionnaire 102 is presented at a first date, questionnaire 104 presented at a specified checkup date later, questionnaire 106 is presented still later, and questionnaire 108 is presented after that.

The answers or responses to questionnaires 102, 104, 106, and 108 are fed through process 130 into database 112. Specifically, the responses are fed into analytics engine 116, which determines a rate at which patient 134 is better able to walk. This data, along with data from many others, can establish a nominal, average rate or other statistics measuring how a normal patient will reach his or her goal.

Patient 136 was pregnant and is now recovering from childbirth. In her convalescence, she is having difficulting walking Question 114 (relating to the ability to walk) is taken from database 112 in step 128 for the questionnaires that will be presented to patient 136. Timeline 122 is selected for questionnaires 118 and 120 to be presented to patient 136. That is, questionnaire 118 is presented at a first date, and questionnaire 120 is presented at a second date, a specified number of days later.

The answers or responses given by patient 136 to questionnaires 118 and 120 are fed in process 132 into database 112. Specifically, the responses are fed into analytics engine 116, which determines a rate at which patient 136 is progressing in her ability to walk.

The rate and progress at which patient 136 is better able to walk is compared with a statistical average recovery rate for walking From that comparison, results can be provided to the patient. The patient and other shareholders can use this information to delve into anomalies, for example if the patient is not improving walking as fast as expected. For example, a doctor may prescribe different medicines, or a different physical therapy exercises can be tried.

Further, the data from patient 136 is added to the database to establish a new norm. A salient aspect of collecting data this way is that answers by patients with different condition to different surveys can be directly compared because the question itself is the same between the different surveys. Question 114 pertains to the ability to walk and is not specific to a leg injury or being pregnant. That is, the question is based on a functional classification of a body part, not the specific ailment.

A “statistical average” of a set of values includes a mean value of the values with a reasonable confidence level or as otherwise known in the art.

A “rate of change” of a value includes a difference in the value with respect to time, procedures, or other events, or as otherwise known in the art.

A “standard classification of functioning” of a body portion or organ includes the WHO ICF, or other accepted standards of functioning as known in the art.

An outcomes dataset can be built that is based on standardized systems of classifying function of the whole body or of organs. This can allow for ease of use and unrestricted worldwide comparisons of aggregate patient populations across national boundaries in culturally diverse regions of the world for the purposes of understanding the efficacy of all of rehabilitation medicine. As shown, even though the above patients' ailments are drastically different, their body functions can be compared with one another. And the more data the better. Thus, the same question, neutral to language or cultural differences, can have answers that allow people across such boundaries to be compared with one another.

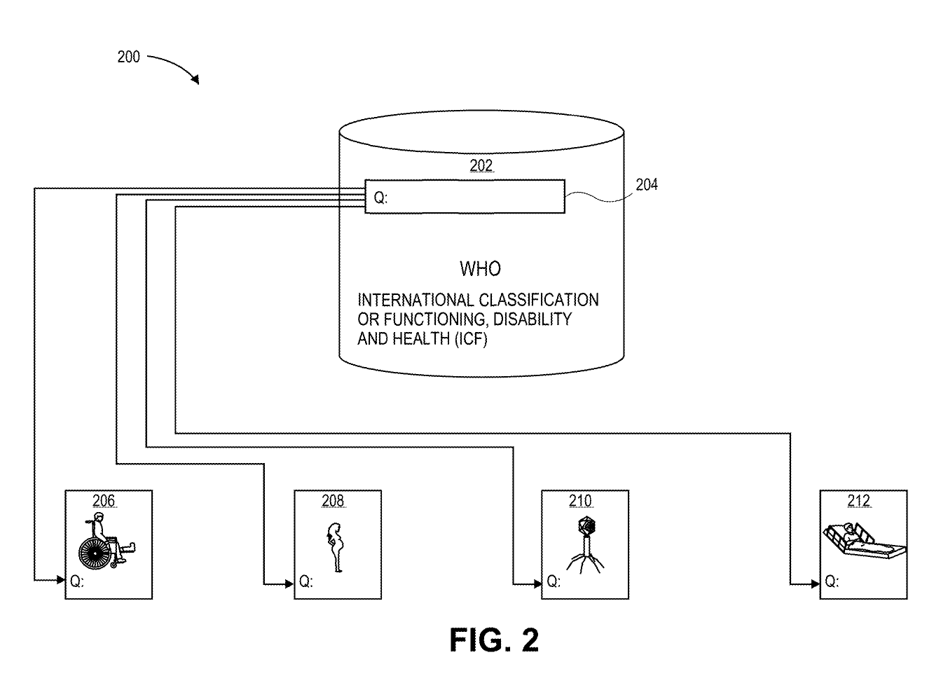

FIG. 2 illustrates a standard question from the International Classification of Functioning, Disability and Health (ICF) used in different questionnaires in accordance with an embodiment. In system 200, a question for a survey can be derived from codes in the International Classification of Functioning, Disability and Health, which is promulgated by the World Health Organization.

Question 204 is derived from database 202, a standardized ICF accepted by many health providers world wide. Surveys 206, 208, 210, and 212, each containing question 204, may involved different patients with different ailments, in different countries speaking different languages. But the substance of question 204 essentially remains the same. Thus, the answers to the questions will inherently be more comparable with one another than those from surveys that are not standardized or relate to body part/organ function.

Of course, patients of different ages, genders, and other demographics may heal differently. Setting up a new patient in the database can include inputting such demographic data.

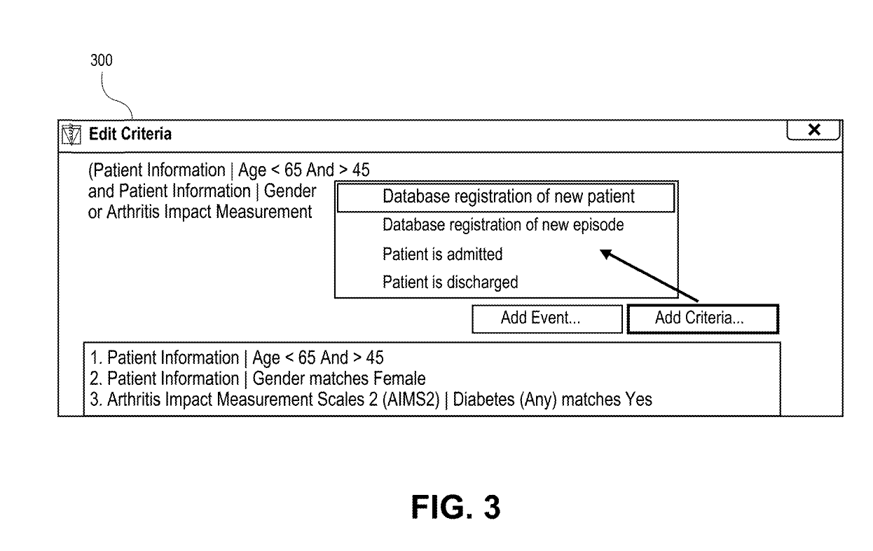

FIG. 3 is a screenshot showing editing criteria by selecting follow-up triggers (e.g., database registration of a new patient, database registration of a new episode, patient is admitted, patient is discharged) according to an embodiment. A new patient can be registered with a view towards presenting surveys specific to that patient's health problems at specific point in time or triggered by certain events. On the database side, every new patient that fits certain criteria may be sent surveys pertaining to an issue. Screen shot 300 shows such criteria being entered.

A number of criteria may be part of a follow-up trigger. Examples of criteria could be patients over the age of 65, patients with total hip implants, or patients who are 6 months post operative. In the exemplary case, all patients whose ages are between 45 and 65 that are female and have diabetes may be registered to receive standardized questions in a questionnaire.

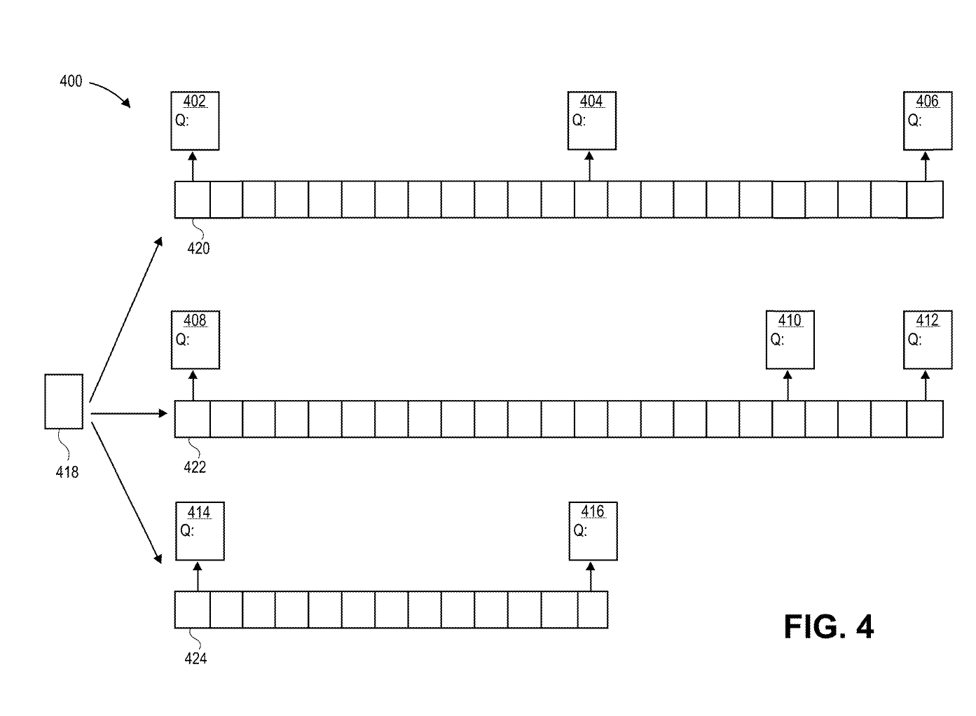

FIG. 4 illustrates selecting different timelines for presenting a survey to a patient according to an embodiment. In selection 400, three different timelines are defined. Which timeline is selected depends upon a patient's answers to initial, entry survey 418.

Timeline 420 includes dates for three questionnaires, questionnaires 402, 404, and 406, to be emailed to the patient. As shown in the figure, these dates are spread relatively evenly in time from one another.

Timeline 422 also includes dates for three questionnaires to be emailed to the patient. However, these questionnaires, questionnaires 408, 410, and 412 are not evenly spread in time. The two questionnaires at the end, i.e., questionnaires 410 and 412, are closely spaced. This may be for several reasons, such as expected progression at the end when a cast comes off, or when a medication is expected to rapidly dissipate fever.

Timeline 424 includes dates for two questionnaires, questionnaires 414 and 416, to be emailed to the patient. As shown in the figure, these dates are spread similarly to those for questionnaires 402 and 404 in timeline 420. Only two questionnaires are necessary as determined by the selection from entry survey 418. This may be for reasons preprogrammed in the automated rule(s) for selected the timelines. For example, the demographic of the patient may bode well for quick healing, and thus less surveys are necessary than for one of another demographic.

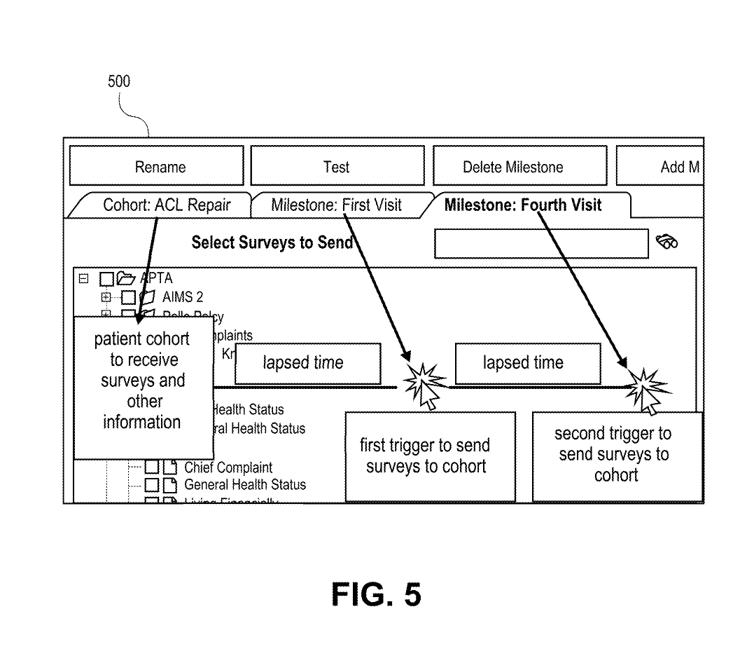

FIG. 5 is an annotated screenshot showing patient data collection automation according to an embodiment. Screenshot 500 shows tabs for when surveys will be sent. For example, for an ACL (anterior cruciate ligament) repair, a patient is to receive a first survey, and then after some lapsed time the patient is to receive a second survey. After still more lapsed time, a third survey is sent to the patient. The timing of the second and third surveys is contemporaneous with the patient's first and fourth visits to the doctor, respectively. As an example, this could be on the same schedule as timeline 420 (see FIG. 4).

Patient outcomes data collection can be automated by database milestones that are defined by patient cohort. Interactive e-mails are sent to the patient's personal computer (PC) or directly to kiosks on campus by a plurality of patient demographic, disease, treatment, and scheduling data points. Metrics from the collected outcomes data are used in tuning treatment pathways and in the warm handoff of patient care to rotating healthcare staff. For example, a patient's metrics can be displayed on a large ‘white board’ display alongside statistics for similarly situated individuals.

Outcomes or health status survey automation rules may have ‘send’ dependencies linked to events within the episode of care, for example:
first clinical visit;
arrival of patient for first clinical visit;
scheduling a re-evaluation by referring physician;
electronic hospital records data feeds such as registration, procedure, or lab results; and
specific patient responses to previous surveys.

To the last point, for example, when a patient responds to a general medical history survey with an affirmative for history of heart disease, a ‘send’ command can be invoked to e-mail a follow up cardiac risk assessment survey to the patient.

Survey automation rules may also have dependencies of data fields contained in the patient electronic chart such as the date of anticipated discharge.

The origin of this aspect is rooted in the fact that healthcare providers are experiencing escalating requirements for outcomes documentation. The feature described here uses patient demographic, chart data fields, diagnostic results and patient responses to surveys to define a patient group or cohort to receive surveys and other information. Any number of milestones or follow up triggers may act to send sets of surveys or information. Milestones or follow up triggers may be events or dates of events. Surveys, my connect forms, or information may be sent using the automation feature.

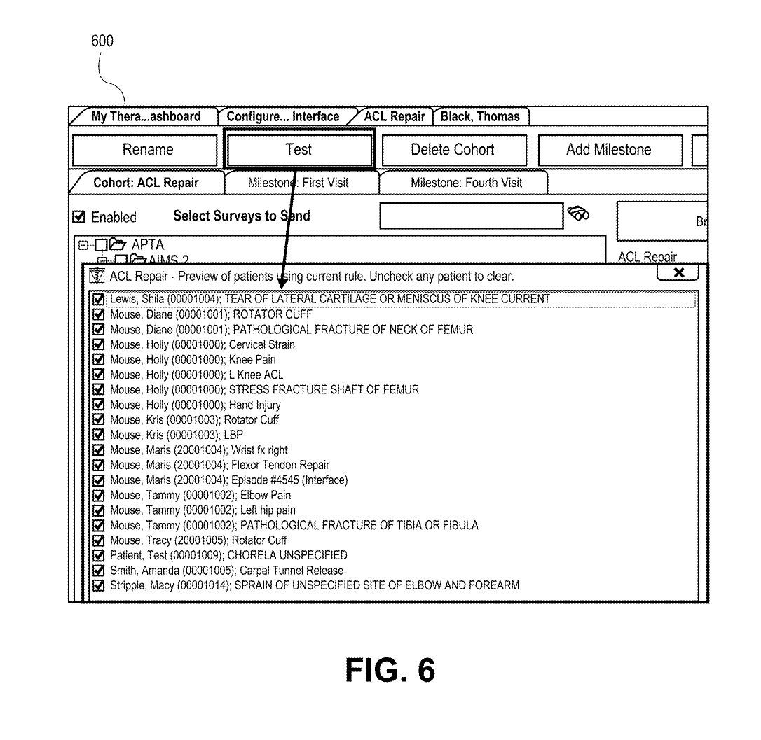

FIG. 6 is a is a screenshot showing an example of testing a cohort by executing a query of the patients that match the cohort definition and then displaying the results. As evidenced in screenshot 600, a query was executed in response to activation of an on-screen “Test” button. However, other techniques of invoking the query could be used. The query could be set up as shown in FIG. 3.

The terms “milestone” and “trigger” are sometimes used interchangeably, although it should be noted that milestones tend to be events that can (but need not) be used to trigger an operation.

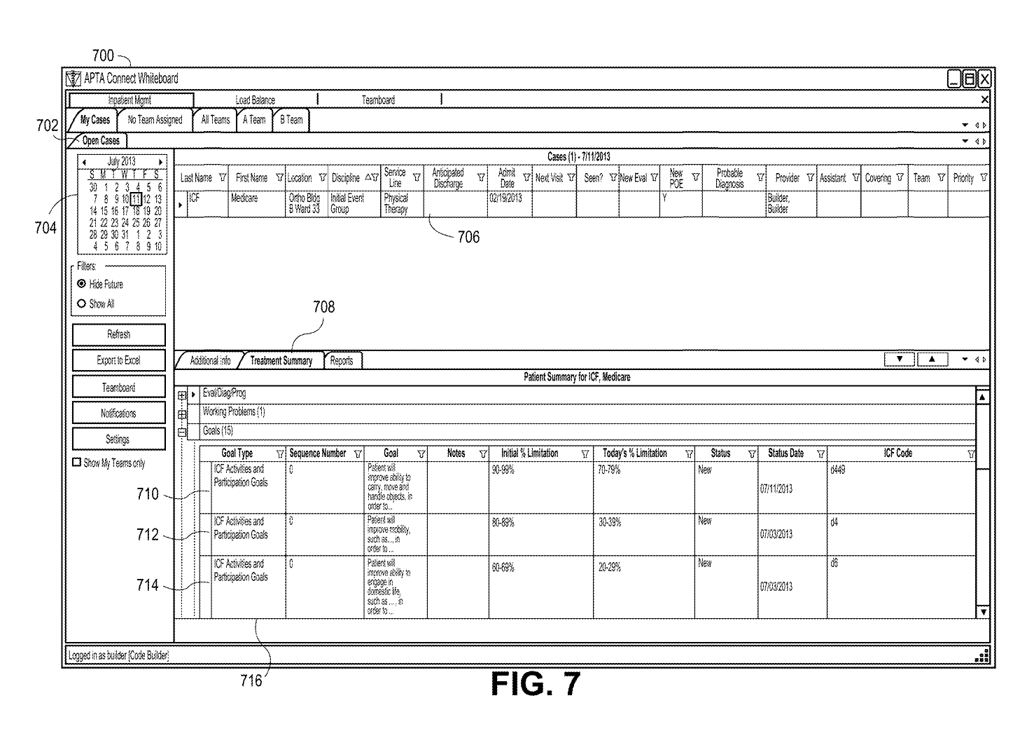

FIG. 7 is a screenshot of a large format display for a warm/soft hand off in accordance with an embodiment. Screenshot 700 includes an American Physical Therapy Association (APTA) electronic whiteboard. Open cases are shown on tab 702, and calendar 704 can be used to select a date of interest.

Within open cases tab 702 are cases for the selected date, including case 706. Also shown is treatment summary 708 for an individual patient, with goals shown on grid 716. Each row of grid 716 is for a different ICF code. First row 710 corresponds to ICF code d449 (“Carrying, moving and handling objects, other specified and unspecified”). The patient's initial percentage limitation is 90-99%, and the goal for today is to achieve a 70-79% limitation. Second row 712 corresponds to ICF code d4. The patient's initial percentage limitation was 80-89%, and the goal for today is to achieve a 30-39% limitation. Third row 714 corresponds to ICF code d6. The patient's initial percentage limitation for this code was 60-69%, and the goal for today is to achieve a 20-29% limitation. Twelve other rows are occluded from view, but they follow a similar design as the first three rows.

Screenshot 700 can be shown on a large format display for many stakeholders to see at once. For example, a projector at a nurses station may project the status on a screen so that doctors, nurses, visiting family, etc. can see the progress of the patient. An average rate of change of the functional ability of patients' legs, for example, can be compared with the a present patient's rate of change of the functional ability if his legs by displaying how many days it might take to go to the next level in recovery progression. Alternatively or in addition, a goal for the patient may be selected based on a calculation from the statistical average. For example, recovery from 50% (severe) impairment in walking to 25% (moderate) may take 14 days on average for a person of the same age. Thus, a goal may be projected to be in the moderate category 14 days out.

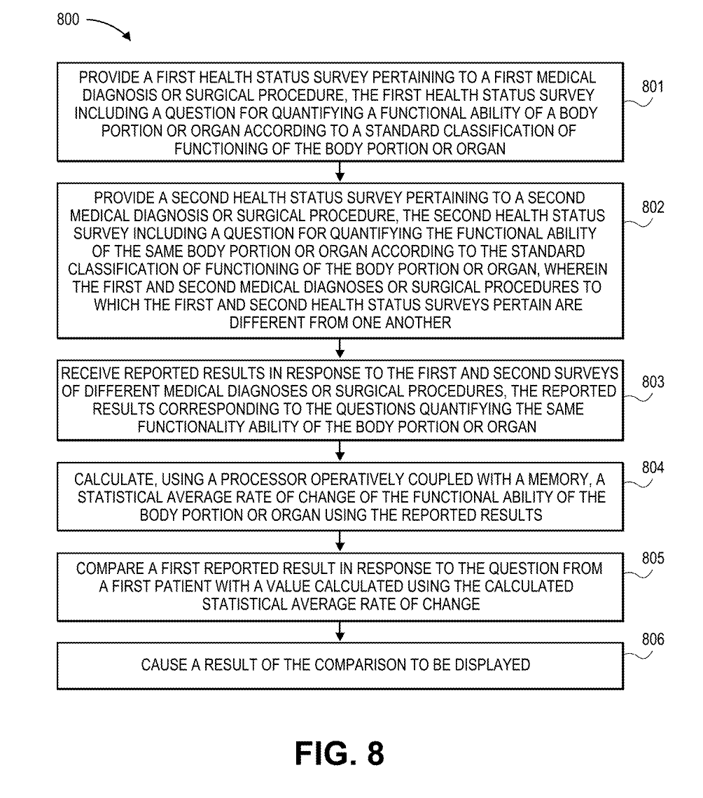

FIG. 8 is a flowchart of a process in accordance with an embodiment, showing process 800. These operations can be executed in a computer system or as otherwise known in the art. In operation 801, a first health status survey pertaining to a first medical diagnosis or surgical procedure is provided, the first health status survey including a question for quantifying a functional ability of a body portion or organ according to a standard classification of functioning of the body portion or organ. In operation 802, a second health status survey pertaining to a second medical diagnosis or surgical procedure is provided, the second health status survey including a question for quantifying the functional ability of the (same) body portion or organ according to the standard classification of functioning of the body portion or organ, wherein the first and second medical diagnoses or surgical procedures to which the first and second health status surveys pertain are different from one another. In operation 803, reported results are received in response to the first and second survey of different medical diagnoses or surgical procedures, the reported results corresponding to the questions quantifying the (same) functional ability of the body portion or organ. In operation 804, a statistical average rate of change of the functional ability of the body portion or organ is calculated, using a processor operatively coupled with a memory, using the reported results. In operation 805, a first reported result in response to the question from a first patient is compared with a value calculated using the calculated statistical average rate of change. In operation 806, a result of the comparison is caused to be displayed.

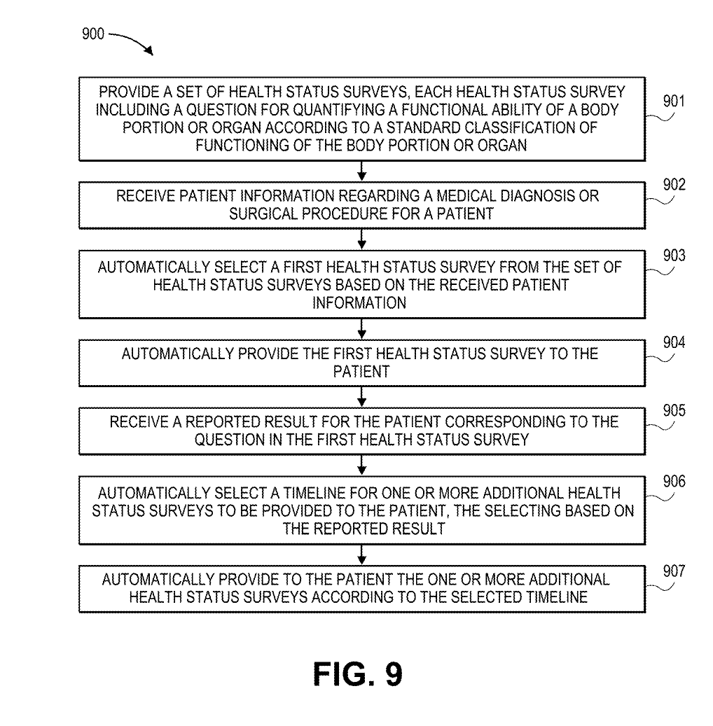

FIG. 9 is a flowchart of a process in accordance with an embodiment, showing process 900. In operation 901, a set of health surveys are provided, each health status survey including a question for quantifying a functional ability of a body portion or organ according to a standard classification of functioning of the body portion or organ. In operation 902, patent information is received regarding a medical diagnosis or surgical procedure for a patient. In operation 903, a first health status survey is automatically selected from the set of health status surveys based on the received patient information. In operation 904, the first health status survey is automatically provided to the patient. In operation 905, a reported result for the patient corresponding to the question in the first health status survey is received. In operation 906, a timeline is selected for one or more additional health status surveys to be provided to the patient, the selecting based on the reported result. In operation 907, the patient is automatically provided the one or more additional health status surveys according to the selected timeline.

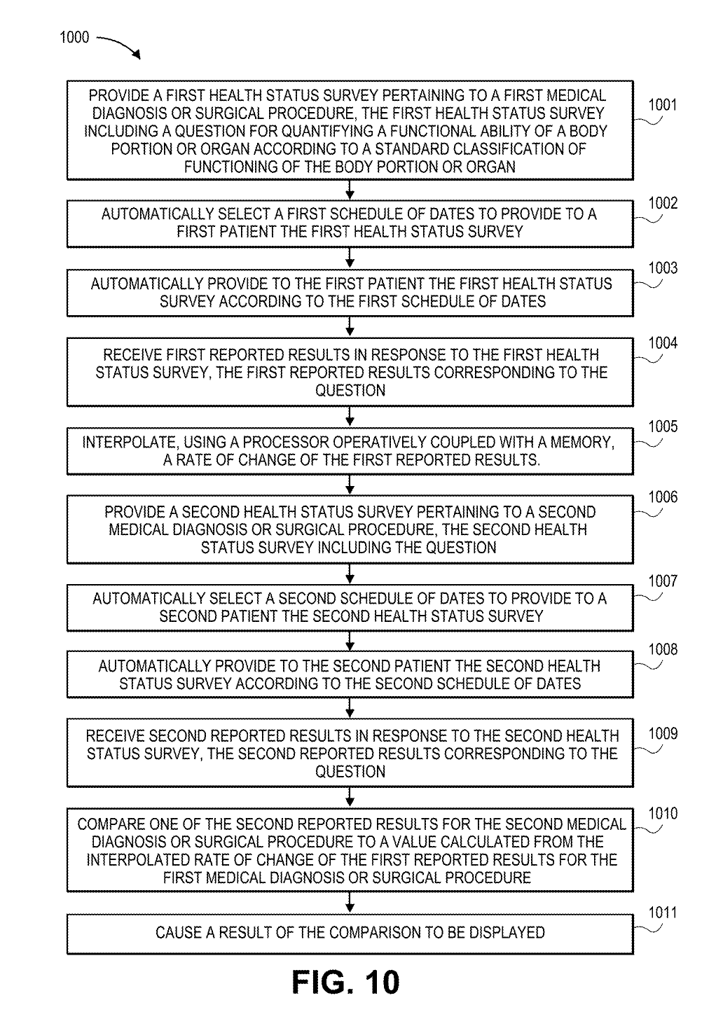

FIG. 10 is a flowchart of a process in accordance with an embodiment, showing process 1000. In operation 1001, a first health status survey pertaining to a first medical diagnosis or surgical procedure is provided, the first health status survey including a question for quantifying a functional ability of a body or organ according to a standard classification of functioning of the body portion or organ. In operation 1002, a first schedule of dates to provide to a first patient the first health status survey is automatically selected. In operation 1003, the first health status survey is provided to the first patient according to (e.g., on each of) the first schedule of dates. In operation 1004, first reported results are received in response to the first health status survey, the first reported results corresponding to the question. In operation 1005, a rate of change of the first reported results is interpolated, using a processor operatively coupled with a memory. In operation 1006, a second health status survey pertaining to a second medical diagnosis or surgical procedure is provided, the second health status survey including the (same) question. In operation 1007, a second schedule of dates to provide to a second patient the second health status survey is automatically selected. In operation 1008, the second health status survey is provided to the second patient according to (e.g., on each of) the second schedule of dates. In operation 1009, second reported results are received in response to the second health status survey, the second reported results corresponding to the (same) question. In operation 1010, one of the second reported results for the second medical diagnosis or surgical procedure is compared with a value calculated from the interpolated rate of change of the first reported results for the first medical diagnosis or surgical procedure. In operation 1011, a result of the comparison is caused to be displayed.

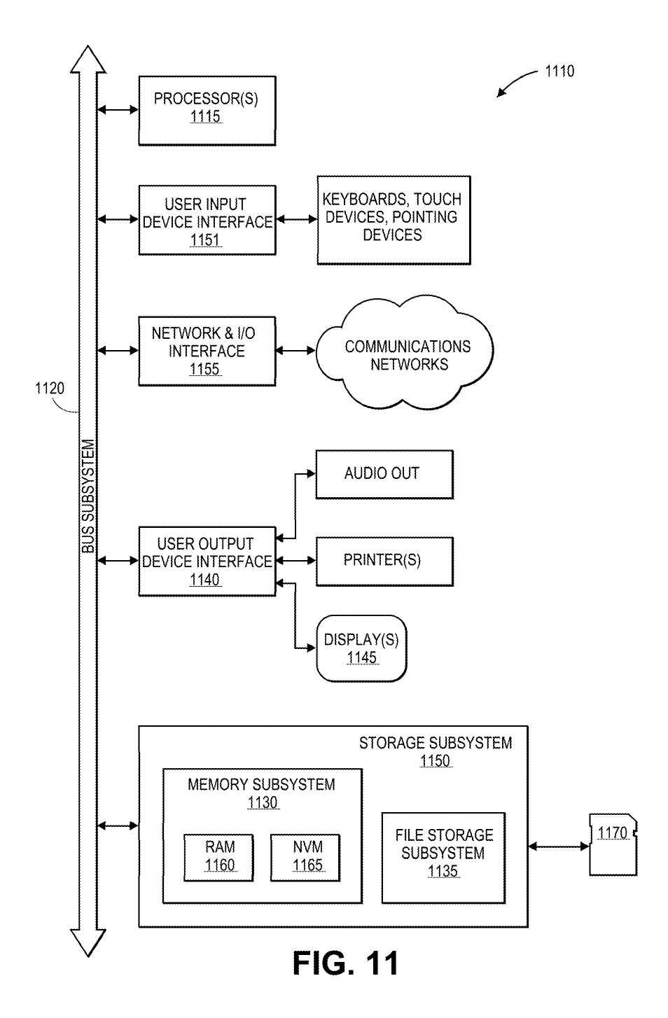

FIG. 11 is a circuit block diagram of a typical computer system 1110 that can be used to implement any of the server or client computers or workstations discussed above. Computers programmed in accordance with embodiments of the present invention are not prior art. It should be understood that various of the computers that cooperate in accordance with embodiments of the present invention do not need to contain all the components shown, and further that they may contain additional components.

The computer system typically includes at least one processor 1115, which can be a conventional microprocessor or microcontroller. The processor can communicate with a number of peripheral devices via a bus subsystem 1120. Bus subsystem 1120 provides a mechanism for letting the various components and subsystems of the computer system to communicate with each other as intended. Although bus subsystem 1120 is shown schematically as a single bus, embodiments of the bus subsystem may utilize multiple buses, and various of the components may have private connections. Although the specifically described embodiments of the present invention are processor-based embodiments, other embodiments can be implemented with other types of controllers such as combinatorial logic.

In addition to storage subsystem 1150, which is shown as having a memory subsystem 1130 and a file storage subsystem 1135, the devices on the bus can include various interface controllers for interfacing to other devices or functional elements that do not interface to other devices. In the representative configuration shown in the figure, the additional devices include a user output device interface 1140 (shown coupled to a display 1145, an audio output device, and a printer), a user input device interface 1151 (shown coupled to devices such as keyboards, touch devices, pointing devices), a network and I/O interface 1155 (shown coupled to a communications network).

Embodiments of the present invention can be implemented with many different types of processor, including embedded processors such as processors using the ARM architecture (a RISC architecture designed by ARM Limited). Others can use microprocessors such as those provided by Intel, AMD, etc.

Storage subsystem 1150 can include various types of storage media, and stores the basic programming and data constructs that provide at least some of the functionality of computer system 1110 For example, the various program modules and databases implementing the functionality of the system may be stored in storage subsystem 1150. The software modules are generally executed by processor(s) 1115. In the case of some of the servers, the storage subsystem is used to store various databases such as patient information databases, which may account for a significant portion of the overall storage capacity.

Memory subsystem 1130 typically includes a number of memories including a main random access memory (RAM) 1160 for storage of instructions and data during program execution and a non-volatile memory (NVM) 1165 in which fixed instructions and fixed system parameters are stored. While the non-volatile memory may be a ROM, rewritable non-volatile memories such as flash EPROMs may be used.

File storage subsystem 1135 provides persistent (non-volatile) storage for program and data files, and may include, for example, one or more hard disk drives and/or flash memory drives. Additionally the file storage subsystem may support associated removable media 1170, e.g., flash memory cards such as those used in digital cameras and mobile phones. Possible types of flash memory cards include but are not limited to Secure Digital (SD), CompactFlash (CF), Memory Stick (MS), MultiMediaCard (MMC) xD-Picture Card (xD), and SmartMedia (SM).

Network and I/O interface 1155 operates, for wired connections, to provide output signals and receive input signals to and from outside entities. As mentioned above, it is shown connected to a communications network.

I/O interface 1155 may include one or more peripheral interfaces such as USB, IEEE 1394 (Firewire), and Bluetooth (a short-range wireless communication standard developed by the Bluetooth SIG and licensed under the trademark Bluetooth®). The I/O interface may also or alternatively include one or more wired networking interfaces (e.g., Ethernet) or wireless networking interfaces (e.g., Wi-Fi adhering to one of the 802.11 family standards, digital mobile phone technologies). Thus, depending on the embodiment, I/O interface 55 can provide an interface to one or more host computers, one or more networks, or accessories coupled to the computer system 1110. The I/O subsystem need not be configured for all these possibilities; it can be very limited in scope for some embodiments.

The user input devices coupled to user input device interface 1151 may include one or more of any or all of the following: keyboards; pointing devices such as mice, trackballs, touchpads, or graphics tablets; scanners, barcode scanners; touchscreens incorporated into displays; audio input devices such as voice recognition systems, microphones, and other types of input devices. In general, use of the term “user input device” is intended to include all possible types of devices and ways for a user to input information into computer system 1110.

In the figure, one user output device coupled to user output device interface 1140 is a display. The present invention does not rely on any particular type of display, although suitable candidates can include liquid crystal displays (LCDs) or light emitting diode (LED) displays. Some computer systems can also provide non-visual display such as audio output. In general, use of the term “user output device” is intended to include all possible types of devices and ways to output information from computer system 1110 to a user. In typical computer systems, the primary display is a visual display, which is used to display visual characteristics of the media assets (e.g., in the case of videos, images, and the like) and metadata (perhaps displayed in lists or in hierarchical menus).

In some embodiments of the present invention, user input devices can include a touch sensitive element overlaying display 1145, providing a touch screen interface.

Embodiments of the present invention are not limited to any particular way that the hardware is partitioned amongst the different blocks. Some hospitals may require that one or more of a service provider's applications be run on hospital-controlled hardware while others may have the service provider host all the services.

At the level of individual workstations, there may be some instances where the applications described in connection with healthcare provider workstations and the applications run on outcome status and hand-off workstations be run on the same hardware. For example, some administrators might want the convenience of having a single physical workstation computer that can run both applications.

However, the patient outcome tracking and hand-off workstations may be deployed in patients' rooms and at central nursing stations, and it can be important that the information be very readily accessible, which militates toward devices that are not used for a wide variety of other purposes.

While the above is a complete description of specific embodiments of the invention, the above description should not be taken as limiting the scope of the invention as defined by the claims.

What is claimed is:

1. A method of quantifying and assessing patient health, the method comprising:
providing a first health status survey pertaining to a first medical diagnosis or surgical procedure, the first health status survey including a question for quantifying a functional ability of a body portion or organ according to a standard classification of functioning of the body portion or organ;
providing a second health status survey pertaining to a second medical diagnosis or surgical procedure, the second health status survey including a question for quantifying the functional ability of the same body portion or organ according to the standard classification of functioning of the body portion or organ, wherein the first and second medical diagnoses or surgical procedures to which the first and second health status surveys pertain are different from one another;
receiving reported results in response to the first and second surveys of different medical diagnoses or surgical procedures, the reported results corresponding to the questions quantifying the same functional ability of the body portion or organ;
calculating, using a processor operatively coupled with a memory, a statistical average rate of change of the functional ability of the body portion or organ using the reported results;
comparing a first reported result in response to the question from a first patient with a value calculated using the calculated statistical average rate of change; and
causing a result of the comparison to be displayed.

2. The method of claim 1 wherein the standard classification of functioning of the body portion or organ is from the International Classification of Functioning, Disability and Health (ICF) as promulgated by the World Health Organization.

3. The method of claim 1 wherein the comparing includes a rate of recovery comparison.

4. The method of claim 1 wherein the first and second health status surveys pertain to different patient demographics.

5. The method of claim 1 further comprising:
displaying the result of the comparison on a large format display.

6. The method of claim 1 further comprising:
displaying the result of the comparison at a nurses station or family waiting area.

7. The method of claim 1 wherein the operations are performed in the order shown.

8. The method of claim 1 wherein each operation is performed by the processor operatively coupled with the memory.

9. A machine-readable storage medium embodying information indicative of instructions for causing one or more machines to perform the operations of claim 1.

10. A computer system executing instructions in a computer program, the computer program instructions comprising program code for performing the operations of claim 1.

11. A method of quantifying and assessing patient health, the method comprising:
providing a set of health status surveys, each health status survey including a question for quantifying a functional ability of a body portion or organ according to a standard classification of functioning of the body portion or organ;
receiving patient information regarding a medical diagnosis or surgical procedure for a patient;
automatically selecting a first health status survey from the set of health status surveys based on the received patient information;
automatically providing the first health status survey to the patient;
receiving a reported result for the patient corresponding to the question in the first health status survey;
automatically selecting a timeline for one or more additional health status surveys to be provided to the patient, the selecting based on the reported result; and
automatically providing to the patient the one or more additional health status surveys according to the selected timeline.

12. The method of claim 11 wherein the standard classification of functioning of the body portion or organ is from the International Classification of Functioning, Disability and Health (ICF) as promulgated by the World Health Organization.

13. The method of claim 11 further comprising:
selecting a rehabilitative goal for the patient based on the reported result; and
selecting functional ability codes based on the rehabilitative goal, the functional ability codes selected from the standard classification of functioning of the body portion or organ.

14. The method of claim 11 wherein the timeline includes specified time periods between surveys.

15. The method of claim 11 wherein the timeline includes specified visits to a clinician.

16. The method of claim 11 further comprising:
automatically selecting the one or more additional health status surveys based on the reported result.

17. The method of claim 11 further comprising:
selecting the first patient survey based on a patient demographic.

18. The method of claim 11 wherein the providing of the first health status survey to the patient includes emailing the first health status survey to the patient.

19. The method of claim 11 wherein the providing of the first health status survey to the patient includes presenting the first health status survey at a kiosk.

20. A method of quantifying and assessing patient health, the method comprising:
providing a first health status survey pertaining to a first medical diagnosis or surgical procedure, the first health status survey including a question for quantifying a functional ability of a body portion or organ according to a standard classification of functioning of the body portion or organ;
automatically selecting a first schedule of dates to provide to a first patient the first health status survey;
automatically providing to the first patient the first health status survey according to the first schedule of dates;
receiving first reported results in response to the first health status survey, the first reported results corresponding to the question;
interpolating, using a processor operatively coupled with a memory, a rate of change of the first reported results;
providing a second health status survey pertaining to a second medical diagnosis or surgical procedure, the second health status survey including the question;
automatically selecting a second schedule of dates to provide to a second patient the second health status survey;
automatically providing to the second patient the second health status survey according to the second schedule of dates;
receiving second reported results in response to the second health status survey, the second reported results corresponding to the question;
comparing one of the second reported results for the second medical diagnosis or surgical procedure to a value calculated from the interpolated rate of change of the first reported results for the first medical diagnosis or surgical procedure; and
causing a result of the comparison to be displayed.
